(19) United States
(12) Patent Application Publication
(10) Pub. No.: US 2025/0010537 A1
(43) Pub. Date: Jan. 9, 2025

(54) ADDITIVELY REINFORCED THERMOFORMING

(71) Applicant: UT-Battelle, LLC, Oak Ridge, TN (US)

(72) Inventors: Ahmed A. Hassen, Knoxville, TN (US); Christopher J. Hershey, Knoxville, TN (US); Vipin Kumar, Knoxville, TN (US); Vlastimil Kunc, Knoxville, TN (US); David Nuttall, Knoxville, TN (US); Ryan C. Ogle, Knoxville, TN (US); Tyler C. Smith, Knoxville, TN (US)

(21) Appl. No.: 18/762,875

(22) Filed: Jul. 3, 2024

Related U.S. Application Data
(60) Provisional application No. 63/524,944, filed on Jul. 5, 2023.

(51) Int. Cl. B29C 51/02; B29C 51/00; B29C 51/12; B29C 51/14; B29C 51/42; B29K 21/00; B29K 55/02; B29K 67/00; B29K 75/00; B29K 77/00; B29K 83/00; B29K 105/08; B29K 307/04; B33Y 40/20

(52) U.S. Cl. CPC B29C 51/02; B29C 51/002; B29C 51/12; B29C 51/14; B29C 51/42; B29K 2021/003; B29K 2055/02; B29K 2067/003; B29K 2075/00; B29K 2077/00; B29K 2083/00; B29K 2105/08; B29K 2307/04; B29K 2995/0082; B33Y 40/20

(57) ABSTRACT

A hybrid additive manufacturing and thermoforming method is provided. The method includes additively manufacturing one or more reinforcing structures directly onto a polymer sheet before shaping the polymer sheet onto a mold and/or while the polymer sheet is shaped onto a mold. By leveraging the design control of additive manufacturing, reinforcing structures can be deposited onto the polymer sheet as needed based on the intended application. These reinforcing structures can comprise standard infill patterns or complex custom core designs. The present invention provides an innovative way in which to mass produce custom thermoformed components with an optimal mechanical response.

### CROSS-REFERENCE TO RELATED APPLICATIONS

This application claims the benefit of U.S. Provisional Application 63/524,944, filed Jul. 5, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to an improved method for manufacturing thermoformed structures.

### BACKGROUND OF THE INVENTION

Thermoforming is a polymer manufacturing process in which a polymer sheet is heated until pliable, shaped over a mold, and finally trimmed to create a finished part. Thermoforming is widely used for producing low-thickness composite structures. The thermoforming process begins by heating the polymer sheet to a temperature that allows for the material to sufficiently stretch and form as needed. Once the heating cycle is completed, the polymer sheet is shaped onto a mold and held in place until the final part has solidified.

Thermoforming can be accomplished via several variations. The final part can be completed by draping the heated polymer sheet over the intended form, however both positive and negative air pressure are commonly used to improve tolerances of the final part. Additionally, processes such as plug-assisted vacuum forming and billow forming incorporate additional stretching of the material prior to forming to enable a greater control over the thinning of the final formed sheet. Some commonly thermoformed components including shipping trays, sporting goods, automotive parts, household components, and patient-specific orthodontic aligners.

Manufacturing via thermoforming can provide rapid cycle times, excellent scalability, and significantly reduced tooling costs. The challenges inherent to thermoforming include the difficulty to maintain uniformity of the material temperature and stretching, which can result in numerous sheet defects during forming. In addition, these sheets are typically either unreinforced polymers or reinforced throughout the entire polymer matrix. This is due to difficulties in the production of sheets with custom placement of fibers or stiffeners which are typically built into the mold, removing the need for multi-material sheets.

Further, the parts produced by thermoforming are generally not intended for load bearing applications due to relatively poor mechanical performance. The most prevalent challenge in any thermoforming application is the ability to process structural materials and to maintain sufficient thickness uniformity and prevent any material failure due to thinning during the forming process. The mold can be designed to address this by forming structural ribs; however, the use of structural ribs in the mold can increase the design complexity and the resulting tooling costs.

Accordingly, there remains a continued need for an improved thermoforming manufacturing method that overcomes these and other shortcomings of the prior art.

### SUMMARY OF THE INVENTION

A hybrid additive manufacturing and thermoforming method is provided. The method generally includes additively manufacturing one or more reinforcing structures directly onto a polymer sheet before shaping the polymer sheet onto a mold and/or after the polymer sheet is shaped onto a mold for thermoforming the polymer sheet. By leveraging the design control of additive manufacturing, reinforcing structures can be deposited onto the polymer sheet as needed, based on the intended application. These reinforcing structures can comprise standard infill patterns or complex custom core designs. The present invention provides an innovative way in which to mass produce custom thermoformed components with an optimal mechanical response. The method of the present invention also makes possible the production of flat preforms that can be shipped in a compact form for final thermoforming. The thermoforming operation then produces a high-performance structure via low-cost processing. The method can use existing printing and thermoforming machines or an integrated additive manufacturing and thermoforming system. The potential applications are widespread, as many thermoformed products can realize improvements in the form of weight reduction, manufacturing costs, and quality control.

These and other features of the invention will be more fully understood and appreciated by reference to the description of the embodiments and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. In addition, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIGS. 1A-1D depict various additively manufactured reinforcement patterns for a thermoformed structure.

FIG. 2 is a schematic illustration of a CF/PETG lattice structure that is printed onto a thermoplastic PETG sheet according to the present invention.

FIGS. 3A and 3B illustrate CF/PETG reinforcing structures that are printed onto a thermoplastic PETG sheet according to the present invention.

FIGS. 4A and 4B include graphs depicting tensile data and flexural data for tested samples prepared according to the present invention.

FIG. 5 is a table with tensile data for additively reinforced thermoformed structures prepared according to the present invention.

FIG. 6 is a table with flexural data for additively reinforced thermoformed structures prepared according to the present invention.

### DETAILED DESCRIPTION OF THE CURRENT EMBODIMENT

As discussed herein, the current embodiment relates to a hybrid additive manufacturing and thermoforming method. The method includes additively manufacturing one or more reinforcing structures directly onto a polymer sheet before shaping the polymer sheet onto a mold and/or while the polymer sheet is shaped onto a mold for thermoforming. By leveraging the design control of additive manufacturing, reinforcing structures can be deposited onto the polymer sheet as needed based on the intended application, providing a flexible way in which to mass produce custom thermoformed components with an optimal mechanical response.

More specifically, the method generally includes selecting a polymer sheet that is suitable for thermoforming. The polymer sheet can include a thermoplastic such as acrylonitrile butadiene styrene (ABS), polyethylene terephthalate glycol (PETG), polystyrene, or polyvinyl chloride (PVC), by non-limiting example, depending on the desired properties of the final product. Other polymers can be used in other embodiments. The sheet is not limited to thermoplastics, however, as the sheet can comprise any formable substrate, such as flexible silicone. The polymer sheet can be uniformly thick, optionally possessing a thickness from as little as 0.1 mm (thin-gauge thermoforming) to as much as 15 mm or more (heavy-gauge thermoforming). Thin-gauge polymer sheets can be used to form packaging materials, such as blister packs and clamshells, while heavy-gauge polymer sheets can be used to form durable and structural components, such as automotive parts, appliance housings, and aeronautical parts. The shape of the resulting mold can dictate sheet thickness, as more intricate molds may require thinner sheets for detailed forming, while larger parts may require thicker sheets to maintain structural integrity.

Once the appropriate polymer sheet has been selected, the method includes one or both of the following workflows: (a) additively manufacturing one or more reinforcing structures directly onto the polymer sheet prior to forming the sheet onto the desired mold; and/or (b) additively manufacturing one or more reinforcing structures directly onto the sheet after forming the sheet onto the desired mold. In each workflow, the polymer sheet comprises the build platform for printed reinforcing structures. This step generally includes preparing a three-dimensional computer model of the reinforcing structures in a format for use by a suitable 3D printer, optionally as a stereolithography (.STL) file format. The reinforcing structures are not limited to any one particular application. The reinforcing structures can include, for example, ribbing, lattice patterns, and raised features. The reinforcing structures can be selected in view of the following considerations: load distribution, stress concentration, and integration with the base sheet.

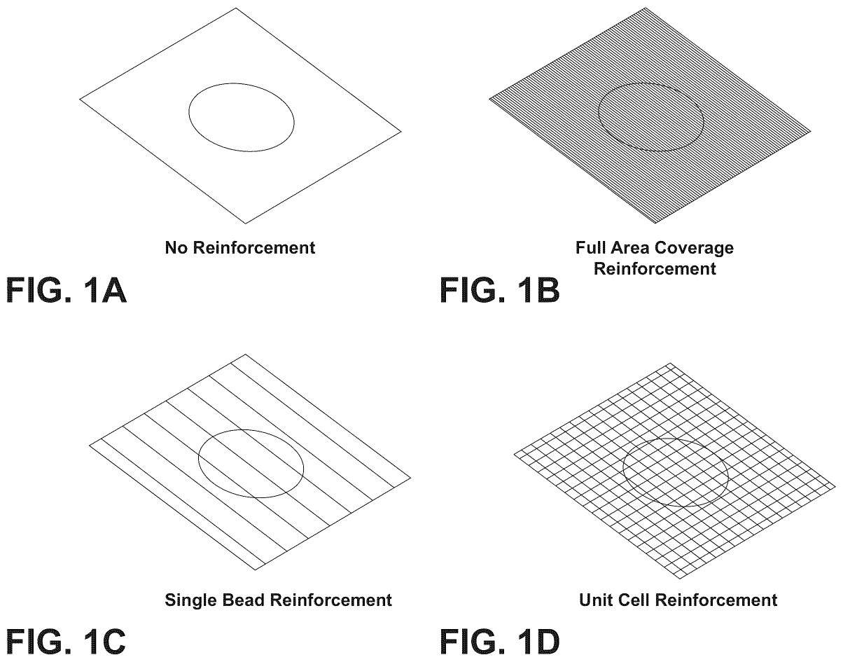

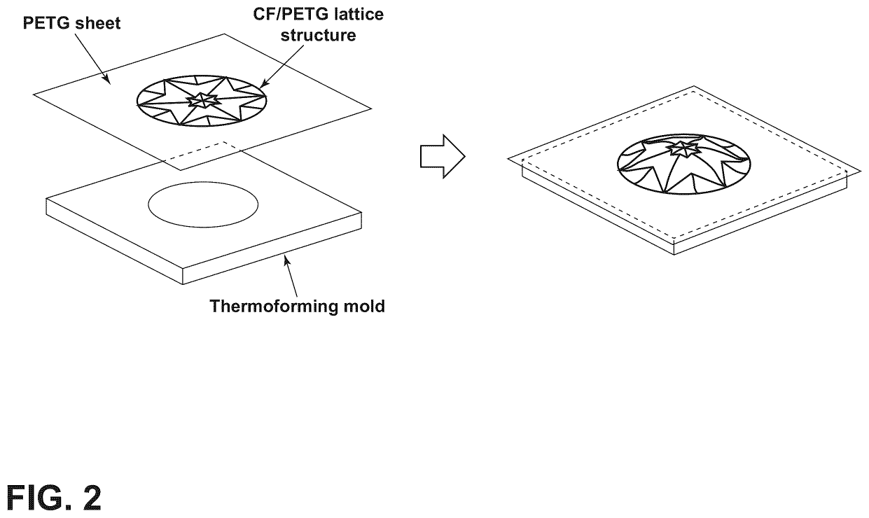

More specifically, the reinforcing structures can include full area coverage reinforcement (FIG. 1B), single bead reinforcement (FIG. 1C), or unit cell reinforcement (FIG. 1D), as contrasted with a polymer sheet having no reinforcements (FIG. 1A). Other reinforcing structures can include a lattice structure, as optionally shown in FIG. 2 for example. More generally, the lattice stricture can include an ordered arrangement of interconnected ridges (curved and/or linear) to form a network of geometric patterns, such as a repeating series of hexagons in a honeycomb configuration. Once the reinforcing structure is prepared as a computer model, the polymer sheet is secured to either of the build plate or a mold. This step can include clips, adhesives, or vacuum beds to ensure the polymer sheet remains in place during printing. The upward-facing surface of the polymer sheet is optionally treated with sanding and/or priming to improve surface bonding between the polymer sheet and the reinforcing structures. The appropriate print parameters are then selected by the operator, including the desired print speed, layer height, and infill density. The three-dimensional print head then deposits material onto the thermoplastic sheet, layer by layer, forming the reinforcing structure.

The reinforcing structure can be selected to exhibit good adhesion to the polymer sheet and pliability when heated, including thermoplastic materials and thermoset materials. Suitable printing techniques include, by non-limiting example, fused filament fabrication and direct ink writing. Other printing techniques can be used in other embodiments, whether now known or hereinafter developed. Suitable thermoplastic materials include, for example, ABS, PETG, thermoplastic polyurethane (TPU), and polyamide (PA). Suitable thermoset materials include, for example, epoxy resins or acrylic resins. Other materials can be used in other embodiments. In addition, the printing material can include fibers (chopped or continuous) within a polymer matrix for enhancing structural properties of the finished part. Suitable fibers include for example carbon fibers, graphite fibers, and pyrolyzed fibers. The fibers are optionally aligned by shear forces during extrusion from a corresponding print head. As the fibers are aligned along the deposition direction, the orientation of any printed reinforcement can be predicted, resulting in improved mechanical performance or to minimize localized stretching of the thermoplastic sheet.

As noted above, the reinforcing structure(s) can be printed onto the polymer sheet before shaping the polymer sheet onto a mold, after shaping a polymer sheet onto a mold, or both before and after shaping the polymer sheet onto a mold. Shaping the polymer sheet generally includes placing the polymer sheet into a thermoforming chamber, typically being held in place by a clamping frame. The sheet is then heated using electric heaters or infrared heaters to evenly heat the sheet until it becomes soft and pliable. Once the sheet is heated to the appropriate temperature, the polymer sheet is transferred to a forming station where a mold is located. The polymer sheet is then shaped onto the mold according to any suitable technique, including vacuum forming, pressure forming, and mechanical forming. The mold can include both male molds (positive molds, in which the sheet is formed over a protrusion), female molds (negative molds, in which the sheet is formed over a recess), and combinations of the same. The polymer sheet is then allowed to cool while remaining in contact with the mold. Cooling can be aided by fans, cooling jets, or water channels in the mold to ensure the final part retains its shape.

In embodiments where reinforcing structures are deposited both before and after shaping onto a mold, the method can include printing a first reinforcing structure into the polymer sheet, shaping the polymer sheet onto a mold, and printing a second reinforcing structure onto the polymer sheet. Optional additional processing steps include trimming, deburring, sanding, and coating the finished part to enhance its appearance and functionality.

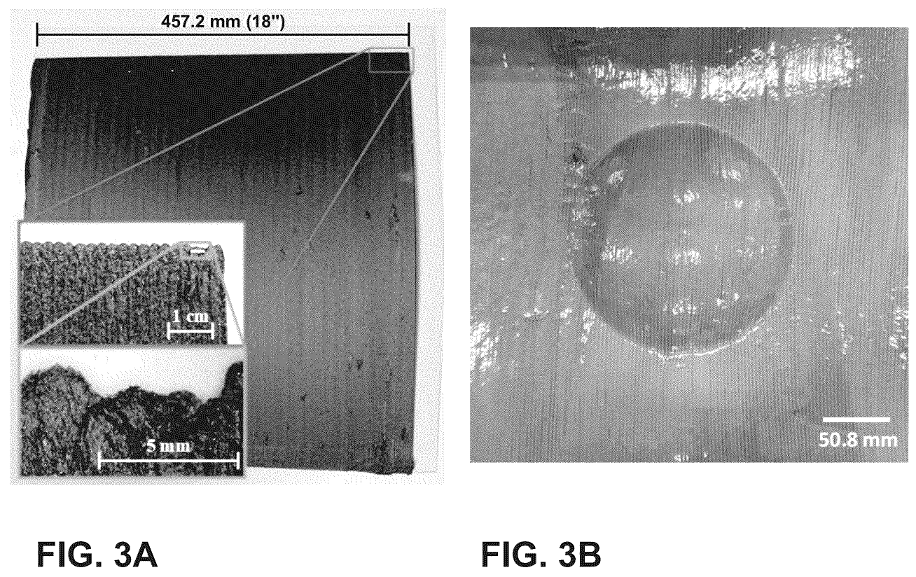

To further illustrate the invention, a laboratory example will now be described. In this example, a single layer of unidirectional carbon fiber (CF)/polyethylene terephthalate glycol (PETG) (commercially available from Push Plastic of Springdale, Arkansas) was printed onto a 19″×20″×0.03″ PETG sheet (commercially available from A&C Plastics of Colorado Springs, Colorado). Thermoforming was performed using a MAAC Comet Thermoformer (commercially available from MAAC Machinery of Carol Stream, Illinois), and all printing was performed using a WorkSeries 400 (commercially available from Dimension Works of Ocala, Florida). Printing parameters included a 1.0 mm nozzle size, an extrusion temperature of 265° C., and a layer height of 0.7 mm. Thermoforming parameters included a heating temperature of 275° C. and a forming time of 30 seconds. FIG. 3A depicts the CF/PETG reinforcing structures printed onto the PETG sheet, and FIG. 3B depicts the sheet after thermoforming onto a male mold.

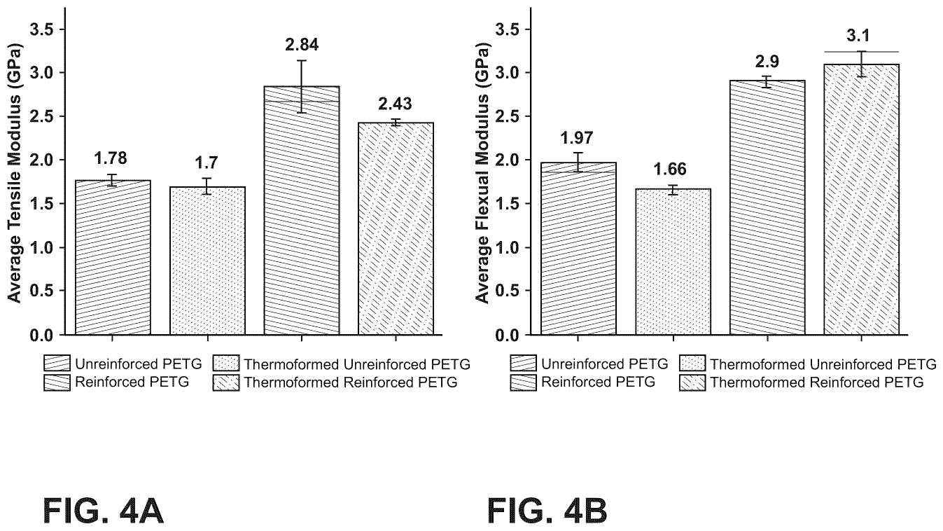

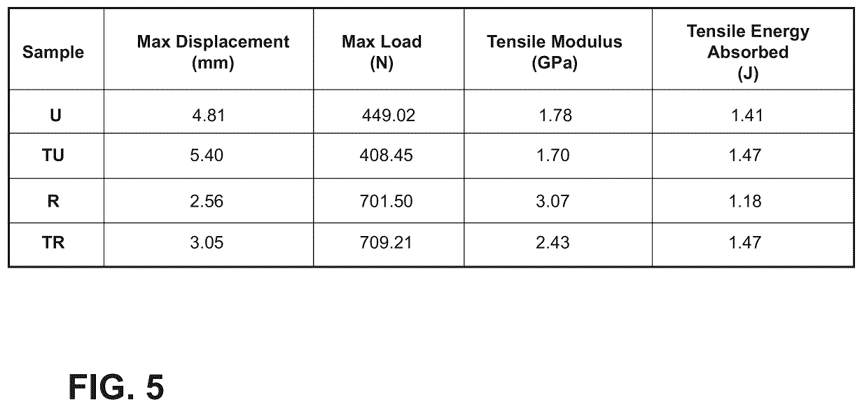

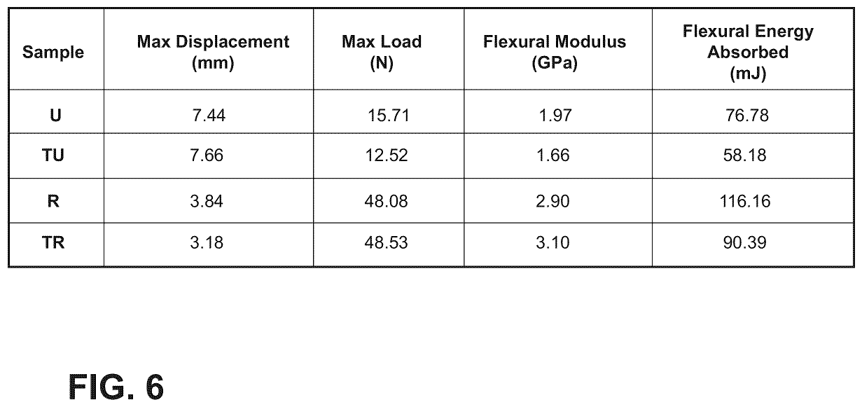

Mechanical testing was then performed using a 50 kN load cell on a TestResources—313 Series universal test frame, including tensile and 3-point bend testing. The results are depicted in FIG. 4A and FIG. 4B against unreinforced PETG and reinforced PETG. The average tensile modulus increased by 51.4% when the 3D-printed reinforcing structures were added to the PETG sheet, and the maximum tensile load rose from 428N to 705N (64.5% increase). The characterization of the materials' flexural properties showed an average flexural modulus approximately 65.3% greater than the unreinforced PETG. The maximum flexural load increased from an average of about 13N to 50N (284% increase) with the addition of a single printed layer. Additionally, the flexural results show an increase in energy absorption from about 67.5 mJ to 103.3 mJ (53% increase). All results are summarized in FIG. 5 (tensile data) and FIG. 6 (flexural data) (as used in FIG. 5 and FIG. 6, U=unreinforced PETG, TU=thermoformed unreinforced PETG, R=reinforced PETG, and TR=thermoformed reinforced PETG).

In all instances, the reinforced specimens were displaced a shorter distance, while withstanding a greater applied load. The thermoformed reinforced samples (TR) showed no signs of delamination and only suffered very slight fractures upon failure. These results speak to the durability of the resulting thermoformed part and the effective adhesion between material layers. The strong adhesion as between the reinforcing structures and the polymer sheet are especially pronounced when using the same thermoplastic, but in some embodiments the reinforcing sheet is different from the material comprising the polymer sheet.

To reiterate, the present invention provides a hybrid additive manufacturing and thermoforming method that provides a wide range of advantages, including minimal operating costs and a short lead time from the initial design to the final part. The rapid production capabilities and low relative cost of both thermoforming and gantry extrusion-based additive manufacturing helps manufacturers improve existing thermoformed components for a wide array of applications. As noted above, this method has two available workflows. In a first workflow, the thermoplastic sheet comprises the build-sheet for 3D-printed reinforcing structures. Once printing is complete, the thermoplastic sheet (with the reinforcing structures) is stored until shipped for thermoforming using a conventional thermoforming machine. In a second workflow, the 3D printer is integrated with the thermoforming machine, providing a system capable of both printing and thermoforming. In this system, the reinforcing structures are printed onto a polymer sheet immediately prior to thermoforming over a mold. Additional printing operations can be performed on the final part inside the system prior to removal. In both workflows, the thermoplastic sheet can remain attached to the printed structures and form the final part, or it can be removed with the printed structures being the final product. The sheet can be either a thermoplastic sheet as used in traditional thermoforming, or an alternative formable substrate, such as flexible silicone.

The deposition of printed structures onto a polymer sheet prior to thermoforming can provide improvements in formability, mechanical performance, and sheet thickness uniformity. With respect to formability, the printed structures can reduce sheet sag. This can result in the ability to process at higher temperatures with reductions in defects due to wrinkling and any hazard due to material falling into the oven. With respect to mechanical performance, the printed structures can comprise stiffening elements (e.g., fiber-reinforced polymers) which can be selectively deposited to provide an optimized reinforcing structure. In addition, the printed structures can be sandwiched between polymer sheets by forming a second sheet onto a first sheet that has 3D-printed reinforcing structures. The mechanical behavior can be reinforced and modified to a degree based on the location and thickness of the reinforcing structures. With respect to sheet thickness uniformity, printed structures having an increased thickness and heat-resistance can be incorporated to regulate the location and degree of material thinning. The thickness of the printed structure is not constrained and can be designed to provide additional local reinforcement or material functionalization as needed. In addition, multiple materials can be selectively applied based on a specific functionality (e.g., electromagnetic interference shielding).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A method comprising:
depositing a first material onto a polymer sheet to form a reinforcing structure by extruding the first material from a print head in successive layers;
heating the polymer sheet and shaping the polymer sheet onto a mold within a thermoforming chamber; and
allowing the polymer sheet to cool while in contact with the mold to form a reinforced thermoformed article and thereafter removing the reinforced thermoformed article from the mold.

2. The method of claim 1, wherein depositing the first material onto the polymer sheet is performed before shaping the polymer sheet onto the mold.

3. The method of claim 1, wherein depositing the first material onto the polymer sheet is performed after shaping the polymer sheet onto the mold.

4. The method of claim 1, wherein the first material and the polymer sheet each comprise a thermoplastic material to promote adhesion of the first material to the polymer sheet.

5. The method of claim 4, wherein the thermoplastic material includes acrylonitrile butadiene styrene, polyethylene terephthalate glycol, thermoplastic polyurethane, or polyamide.

6. The method of claim 1, wherein the first material includes a fiber-reinforced polymer, and wherein the polymer sheet comprises a thermoplastic material.

7. The method of claim 1, wherein the reinforcing structure comprises a lattice structure on an upper surface of the polymer sheet.

8. The method of claim 1, wherein the reinforcing structure comprises repeating rows of raised ribs, wherein the repeating rows of raised ribs are unidirectional.

9. The method of claim 1, wherein reinforcing structure comprises a first plurality of raised ribs oriented in a first direction and a second plurality of raised ribs oriented in a second direction, the second direction being orthogonal to the first direction.

10. The method of claim 1, wherein the polymer sheet comprises flexible silicone.

11. A method comprising:
printing a plurality of reinforcing structures onto an upper surface of a polymer sheet by extrusion from a gantry-supported print head;
heating the polymer sheet within a thermoforming chamber and bringing the polymer sheet into contact with a molding surface, the molding surface having at least one feature;
shaping the polymer sheet onto the molding surface such that the polymer sheet conforms to the at least one feature of the molding surface;
exposing the polymer sheet and the plurality of reinforcing structures to one or more cooling zones while the polymer sheet conforms to the at least one feature of the molding surface;
removing a resulting reinforced thermoformed article from the thermoforming chamber.

12. The method of claim 11, wherein printing the plurality of reinforcing structures is performed before shaping the polymer sheet onto the molding surface.

13. The method of claim 11, wherein printing the plurality of reinforcing structures is performed after shaping the polymer sheet onto the molding surface.

14. The method of claim 11, wherein the plurality of reinforcing structures and the polymer sheet each comprise a thermoplastic material.

15. The method of claim 14, wherein the thermoplastic material includes acrylonitrile butadiene styrene, polyethylene terephthalate glycol, thermoplastic polyurethane, or polyamide.

16. The method of claim 11, wherein the plurality of reinforcing structures includes a fiber-reinforced polymer.

17. The method of claim 11, wherein the plurality of reinforcing structures comprise a lattice structure on the upper surface of the polymer sheet.

18. The method of claim 11, wherein the plurality of reinforcing structures comprise repeating rows of raised ribs, wherein the repeating rows of raised ribs are unidirectional.

19. The method of claim 11, wherein the plurality of reinforcing structures comprise a first plurality of raised ribs oriented in a first direction and a second plurality of raised ribs oriented in a second direction, the second direction being orthogonal to the first direction.

20. The method of claim 11, wherein printing the plurality of reinforcing structures includes extruding from a print head at a first temperature, and wherein heating the polymer sheet is performed at a second temperature that is greater than the first temperature.
